(19) United States
(12) Patent Application Publication
(10) Pub. No.: US 2008/0065519 A1
(43) Pub. Date: Mar. 13, 2008

(54) Management System and Method for a Golf Range

(76) Inventors: Jin Gu Chung, Seoul (KR); Chang Soo Lee, Seoul (KR)

Correspondence Address: SHERR & NOURSE, PLLC, 620 HERNDON PARKWAY, SUITE 200, HERNDON, VA, 20170, US

(21) Appl. No.: 11/572,847

(22) PCT Filed: Jul. 5, 2005
(86) PCT No.: PCT/KR05/02141

§ 371 Date: Jan. 29, 2007

(30) Foreign Application Priority Data
Jul. 30, 2004 (KR) 10-2004-0060614

(51) Int. Cl. G06Q 10/00

(52) U.S. Cl. 705/32

(57) ABSTRACT

The present invention relates to a system and method for managing a golf range. The system for managing a golf range having a plurality of bays, in accordance with the present invention, includes an assignment server for assigning the plurality of bays to assignees, a management server for receiving assignment information from the assignment server, calculating earnings of respective assignees based on the management information for management of the golf range, and providing information about earnings calculated for the respective bays, and a plurality of assignee terminals connected to the servers and configured to be assigned desired bays by the assignment server, and request and receive management information regarding their assigned bays. Accordingly, since the present invention assigns respective bays of the golf range, the assignees of the bays can be individual entrepreneurs, so that a tax reduction effect can be achieved and the present invention can attract individuals who can invest small amounts of money in large golf ranges.

### TECHNICAL FIELD

The present invention relates to a system and method for managing a golf range and, more particularly, to a management system and method that leases respective bays of a golf range and manages the golf range based on the lease information.

### BACKGROUND ART

In general, a golf range, commonly called a driving range, is a place where a plurality of bays is provided at one side of an outdoor area and impact points and distances are indicated thereon in a direction in which golf ball fly, so that a user may practice golf while checking distances and directions in which golf balls fly when the user hits the golf balls. In many cases, golf ranges may be utilized based on yearly membership, monthly membership, multiple use coupons and one-time use coupons. A golfer, having paid usage fees, is assigned a bay at a management desk with the help of a golf range management system constructed using the Internet or computer software, enters into the bay of the golf range, and practices golf using balls supplied by a ball supply means.

Such a conventional method of managing a golf range is illustrated in FIG. 6. Conventionally, golf ranges are managed mainly by two methods, which are illustrated by a first management system 110 and another management system 120. In the first management system 110, a landowner or land lessor (hereinafter referred to as a “constructor”) having constructed a golf range sets up all the facilities and equipments required for golf practice. When the golf range is finished, a business operator 115, such as a constructor, establishes a direct management corporation and manages the golf range through the direct management corporation, or manages the golf range without a direct management corporation. The direct management corporation 111 or a proprietor may acquire earnings by directly managing or leasing subsidiary facilities, such as a golf shop, a restaurant and a coffee shop, in addition to the management of a golf range.

In the second management system 120, a constructor, having constructed a golf range, sets up all the facilities or equipment required for golf practice. When the golf range is finished, a constructor leases the golf range to a management agency 112, and the management agency 112, which is a proprietor or corporation, acquires earnings by directly managing and leasing a golf shop, a restaurant and a coffee shop as well as the golf range and pays lease fees to the constructor.

In order to manage a golf range, a constructor invests his or her own funds for the construction cost, or establishes a corporation and spends the investments of stockholders for the construction cost, manages the golf range, and acquires earnings. However, complicated procedures are required to establish a corporation and attract investors. Even if the golf range is leased, the lessees of the golf range must risk their money on golf range business and pay lease fees.

Furthermore, even if a conventional management corporation is established by a constructor, the management corporation is not a professional management corporation because it does not professionally operate a management system and aims to attract investors and establish the golf range, so that many inefficiencies exist in the management of the golf range. Meanwhile, it is actually difficult for small investors who feel confident in the future of the leisure industry and want to invest their money in golf ranges to participate in the management of golf ranges that require the investment of large amounts of capital.

Furthermore, a constructor or landowner is concerned about leasing the golf range because large amounts of capital is invested due to the high facility cost when a constructor or landowner constructs a golf range using his or her own land, and a tax burden is large due to the large scale of the business, so that many problems arises in the effective management of golf ranges.

### DETAILED DESCRIPTION OF PRESENT INVENTION

Accordingly, the present invention has been made keeping in mind the above problems occurring in the prior art, and an object of the present invention is to provide a management system in which a constructor leases respective bays of a golf range to lessees and entrusts the management of the golf range to a professional management corporation, thus reducing the investment risk and being professionally managed.

Another object of the present invention is to provide a system and method for managing a golf range, which lease respective bays of a golf range to lessees and calculate earnings for the respective bays based on leasing results, thus enabling lessees to manage the bays in the capacity of private entrepreneurs.

Another object of the present invention is to provide a system and method for managing a golf range, which enable a person to invest small amounts of capital in a golf range, and allow the golf range to be transparently managed, thus preventing omissions on tax returns, such as income tax returns, and reducing tax based on business income.

In order to achieve the above-described objects, the present invention provides a system for managing a golf range, the system having a plurality of bays, including an assignment server for assigning the plurality of bays to assignees; a management server for receiving assignment information from the assignment server, calculating earnings of respective assignees based on the management information for management of the golf range, and providing information about earnings calculated for the respective bays; and a plurality of assignee terminals connected to the servers and configured to be assigned desired bays by the assignment server, and request and receive management information regarding their assigned bays.

Furthermore, in accordance with the present invention, the assignment is leases and the assignees are lessees.

Furthermore, in accordance with the present invention, the management server includes an assignment information DB for storing assignment information for the respective assignees; a management information DB for storing detailed information about management of the bays; an assignee DB for storing information about the assignees; a member DB for storing customer member information, a management information input unit for receiving bay-based management information, a control unit for controlling the elements such that earnings are calculated for respective bays based on input management information and assignment information; and a bay-based earning calculation unit for calculating the earnings for respective bays.

Furthermore, in accordance with the present invention, the bay-based earning calculation unit calculates the earnings such that the generated earnings are sequentially distributed to the assignees.

Furthermore, in accordance with the present invention, the bay-based earning calculation unit calculates the earnings such that the earnings are distributed to the assignees based on data on use of the bays, with security deposits and lease fees being differently fixed for the bays.

Furthermore, in accordance with the present invention, the bay-based earning calculation calculates the earnings such that the generated earnings are distributed to the assignees in proportion to the number of bays of each assignee.

Furthermore, in accordance with the present invention, the assignment is registration sales and the assignees are registered owners.

### DESCRIPTION OF DRAWINGS

FIG. 1 is a schematic diagram illustrating a system for managing a golf range in accordance with an embodiment of the present invention;

FIG. 2 is a detailed block diagram illustrating the golf range management server of FIG. 1;

FIG. 3 is a block diagram illustrating a method of managing a golf range in accordance with an embodiment of the present invention;

FIG. 4 is a flowchart illustrating the method of managing a golf range in accordance with the embodiment of the present invention;

FIG. 5 is a view illustrating an earning calculation method according to the present invention; and

FIG. 6 is a schematic diagram illustrating a conventional method of managing a golf range.

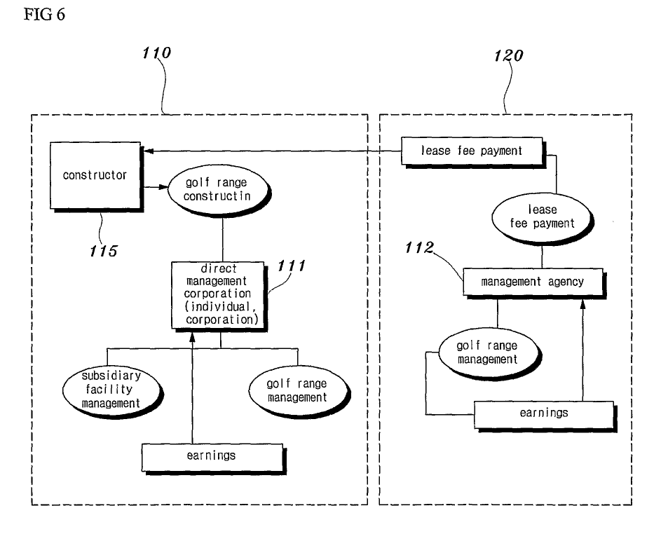

### BEST MODE

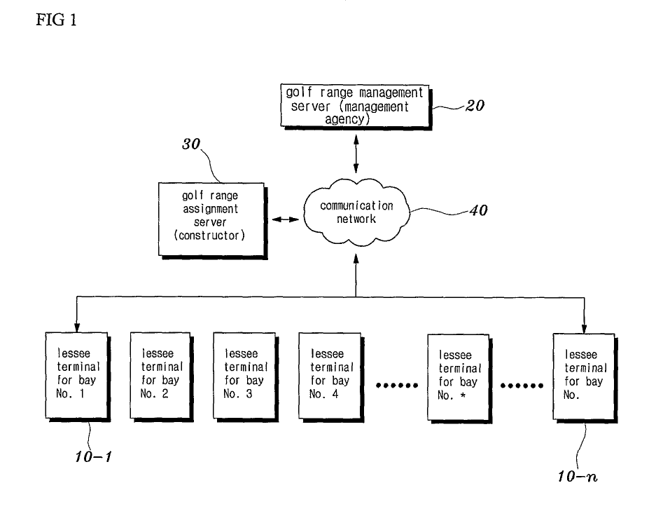

With reference to FIGS. 1 to 5, preferred embodiments of the present invention are described in detail below.

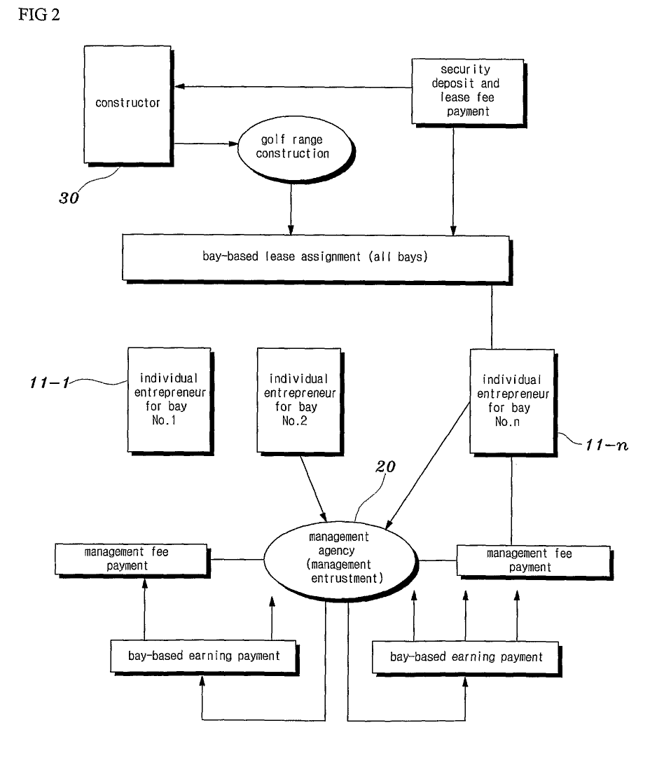

FIG. 1 is a schematic view illustrating a method of managing a golf range according to an embodiment of the present invention, and FIG. 2 is a flowchart illustrating a method of managing a golf range in the golf range management system, in accordance with an embodiment of the present invention.

Referring to FIG. 1, the golf range management system includes first to n-th lessee terminals 10-1 to 10-n connected to n lessees who leased bays, a golf range assignment server 30 for a constructor leasing bays, a golf range management server 20 for receiving bay lease information from the golf range assignment server 30 and managing a golf range, and a communication network 40 for connecting the above-described components and transmitting and receiving data.

Although, in the present embodiment, an on-line scheme in which the golf range assignment server 30 is connected to the communication network 40 is described, it is possible to lease respective bays of the golf range and acquire lease information off-line.

In this case, an on-line golf range assignment server side or off-line lessor side constructor is an entity that leases the bays of a golf range to lessees, and directly manages or leases subsidiary facilities. The constructor may directly manage some of the bays, in which case the golf range assignment server 30 leases the remaining bays other than directly managed bays at the time of leasing the bays of the golf range. The lessees related to the first to n-th lessee terminals 10-1 and 10-n, who lease bays from the golf range assignment server 30 or off-line lessor, can register themselves as private entrepreneurs managing the bays of the golf range and a security deposit can be protected by the lease protection law.

The bay lessees 11-1 to 11-n registered as private entrepreneurs manage and distribute earnings by entrusting the management of bays to a separate management company for earnings, management fees and expenses. That is, a management agency 20 is the operator of the management server, manages earnings acquired from the bays of the golf range, receives information about leasing of bays from the assignment server 30, and distributes earnings to the private entrepreneurs on a bay basis. Furthermore, the private entrepreneurs having leased bays receive earnings from the management server 30 on the bay basis and pay management fees to the management side agency. When the bays of the golf range are managed directly by the constructor 30, the constructor 30 entrusts the management of the bays to a professional company, in other words, the operator of the management server 20, entrusts the management of the bays to the professional management agency, in other words, the operator of the management server 20, receives earnings related to the bays, and pays management fees to the management agency 20.

It is possible for a private entrepreneur having leased a bay to make a contract while determining a lease period. For example, even if a contract for a lease period of 1˜2 years is made, the private entrepreneur can fix a lease period of up to 5 years and notify the constructor of the extension of the lease period according to Korean lease protection law. During the lease period, a security deposit is kept by the constructor for the use of the bays, and lease fees for respective bays are regularly paid to the constructor regardless of the earnings of the bays.

Meanwhile, the golf range management server side management agency is a separate management agency that determines a predetermined amount of management fees for each bay (fees for earnings or a fixed amount of fees), receives the management fees, and takes charge of the operation, management, marketing and safety of the golf range. Furthermore, the golf range management server 20 may deduct the salaries of employees and employee management fees from money received for respective bays, accumulate the money and pay for large-scale repair. The management agency is a company that is set up to manage the golf range and be separate from a landowner, a constructor or lessees. Furthermore, the management agency is preferably a professional company managing only golf range. The reason for this is that the professional company can be differentiated from a conventional management corporation in that the professional company possesses the know-how for the management of the golf range and, therefore, can maximize the efficiency of the management of the golf range. With such a management agency side system being used as the golf range management server 20, the system for managing the golf range and a method for managing the golf range using the system are described in detail below.

Referring to FIG. 1, the constructor posts a bay-based golf range lease notification on the golf range assignment server 30 on-line. Then, the first lessee terminal 10-1 connects to the golf range assignment server 30, requests the lease of a desired bay or the lease of a bay according to sequence, and makes a lease contact, thus completing the lease. The bays of the golf range are leased to the remaining lessee terminals in the same manner. In this case, the golf range assignment server 30 transits lease information mapping lessor-based leased bays to the first to n-th lessee terminals 10-1, . . . , 10-n to the golf range management server 20 through the communication network 40. The communication network 40 may be the Internet. The line between the golf range management server 20 and the golf range assignment server 30 may be an internal communication network (intranet). If the lease was enter into off-line, it is possible to operate the golf range management server 20 by inputting bay-based detailed lease information, such as a security deposit, lease fees and contract conditions, to the golf range management server 20. The golf range management server 20 receives the lease information, stores the lease information for respective lessor, and transmits information about earnings and operational status to the lessee terminals. That is, the lessee terminals request various types of information including information about earnings related to leased bays and current bay status, the golf range management server 20 includes a function of transmitting desired information to lessee terminals desiring the information in response to the requests. Furthermore, the golf range management server 20 enables the golf range to be managed in various ways using bay-based management information based on bay-based lease information.

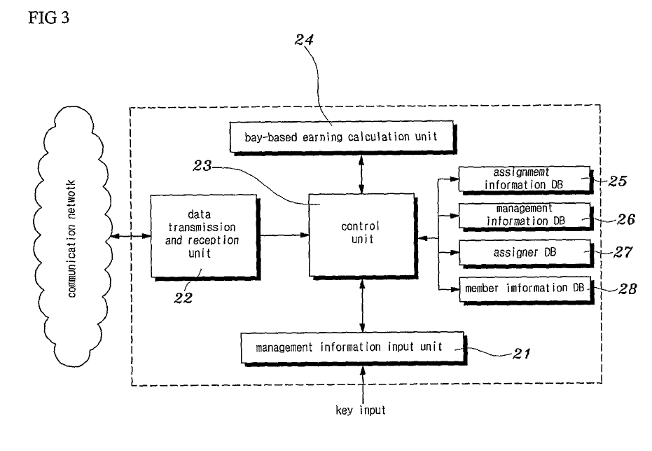

This is described with respect to the detailed block diagram of the golf range management server of FIG. 3.

FIG. 3 is a detailed block diagram illustrating the method of managing the golf range using the golf range management server 20 having bay-based lease information.

The golf range management server 20 of FIG. 3 includes a data transmission and reception unit 22 for transmitting and receiving data in conjunction with a communication network, an assignment information DB 25 for storing lessee based bay lease information, a management information DB 26 for storing detailed information about bay management an assignee DB 27 for storing lessee information, and a member DB 28 for storing customer member information. Furthermore, the golf range management server 20 includes a management information input unit 21 for receiving bay-based management information, a control unit 22 for controlling respective components using the input management information and the lease information, and a bay-based earning calculation unit 24 for calculating bay-based earnings.

The control unit 23 for managing the golf range transmits the information of the assignment information DB 25 and the information of the management information DB 26 to the bay-based earning calculation unit 24 so as to calculate earnings and deduct related expenses. The bay-based earning calculation unit 24 calculates bay-based earnings using the information input form the control unit 23. Furthermore, the control unit 23 stores calculation in the assignee DB 27. Furthermore, the control unit 23 transmits management information or bay-based earning information at they request of lessees. The management information input unit 21 frequently receives the current management status of bays.

The data transmission and reception unit 22 is an interface that is connected to the communication network, receives data requests from the lessee terminals 10-1, . . . , 10-n and enables desired data to be transmitted. Furthermore, the control unit 23 receives golf range management information from the management information input unit 21 in real time, and stores the current status of use of the bays in the management information DB 26. The bay-based earning calculation unit 24 calculates bay-based earnings under the control of the control unit 23. The control unit 23 stores the earnings, which are calculated by the bay-based earning calculation unit 24, in the assignee DB 27 on a lessee basis, and provides information about the earnings at the request of lessees. The earning calculation method varies depending on lease information and management information.

An example is a method in which the sequence of lessees is set and generated earnings are distributed among lessees according to the sequence. The above-described method is a method in which the same earnings are assigned to respective bays on a basic calculation date in consideration of the fact that a difference in circulation rate is large according to bay. That is, the member fees (yearly member fees, monthly member fees and usage fees) of golf range members, which are stored in the member information DB 28, and earnings, which are generated daily regardless of the use of bays, are distributed among the lessees in sequence. When the same earnings are not generated for respective lessees on the basic calculation date, it is possible to start the distribution of earnings from the lessee adjacent to the lessee, who received the most recent earnings, on the date after the basic calculation date so that the same earnings are distributed among the lessees at the end of the year. For example, when the basic calculation date is 31 of May and a person, who received earnings on May 31, is the lessee of bay No. 18, the earnings generated by the first member on June 1 are given to the entrepreneur of bay No. 19.

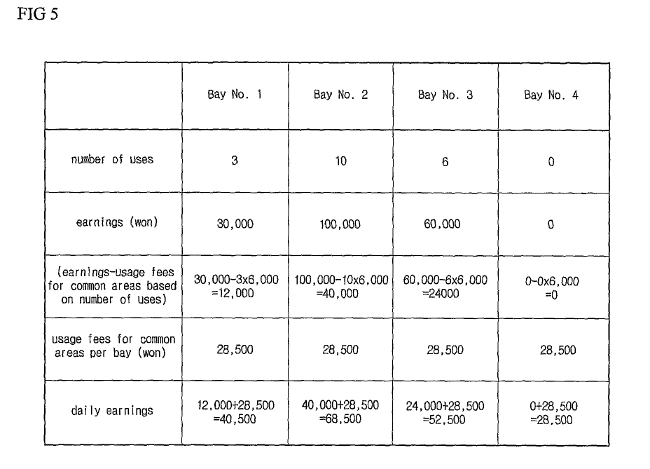

Another calculation method is a method in which earnings are distributed to the lessees of corresponding bays. In this method, a security deposit and lease fees vary according to bay. That is, the numbers of uses of respective bays are estimated, different contract deposits are fixed for respective bays, and separate usage fees are fixed for common areas. Thereafter, usage fees for common areas are additionally collected for bay having high numbers of uses, the same usage fees are collected for bays having low numbers of uses, and the collected usage fees are uniformly distributed for respective bays. If so, the difference between the earnings of bays having high numbers of uses and the earnings of bays having low numbers of uses can be reduced. This is the same as an example shown in FIG. 5.

Referring to FIG. 5, earnings for each bay are obtained by multiplying the total number of uses by usage fees for each use and subtracting common usage fees from the multiplication result. For bay No. 1, earnings of 12,000 won are obtained by multiplying the number of uses, that is, 3, by usage fees for each use, that is, 10,000 won, and subtracting the common usage fees, that is, 18,000 won, from the multiplication result. In FIG. 5, the number of uses of bay No. 2 is 10 for each day, so that earnings related to bay No. 2 are 40,000. For bay No. 4, the number of uses is zero, so that earnings are zero. Furthermore, total common usage fees for a parking lot and a fairway are 118,000 won, and common usage fees for each bay, that is, 28,500 won, are obtained by dividing the total common usage fees by the number of bays, that is, four. If expenses, which correspond to the value, which is obtained by multiplying the total usage fees by the rate of the number of uses of a corresponding bay to the total number of uses of all the bays, are assigned to the corresponding bay, the difference between the earnings of royal bays and other bays is reduced.

Another method is a method of uniformly distributing monthly earnings to lessees in proportion to the number of bays. For example, the dividend can be obtained by dividing the total usage fees of members for four bays by the total number of bays, that is, four. When the total earnings for one day are 190,000 won, the total earnings are divided by the number of bays, that is, four, and earnings for each bay are 47,500 won. Accordingly, lessees receive the same bay-based earnings.

In another earning calculation method, a private entrepreneur directly promotes the use of bays, the earnings of leased bays are the total earnings of the private entrepreneur and the private entrepreneur pays agreed management fees and expenses to the management agency. In this earning calculation method, the difference in earnings may be large for the bays on the same floor. The earnings of bays may increase depending on efforts toward the promotion of the use of bays.

It is apparent that earnings may be calculated using various calculation methods other than the above-described calculation methods. That is, it is apparent that any earning calculation method may be employed according to the agreement between lessees who leased bays and a management agency who actually manages a golf range.

The control unit 23 transits earning calculation results, which are obtained using various methods, to lessee terminals at the request of the lessees that leased the bays.

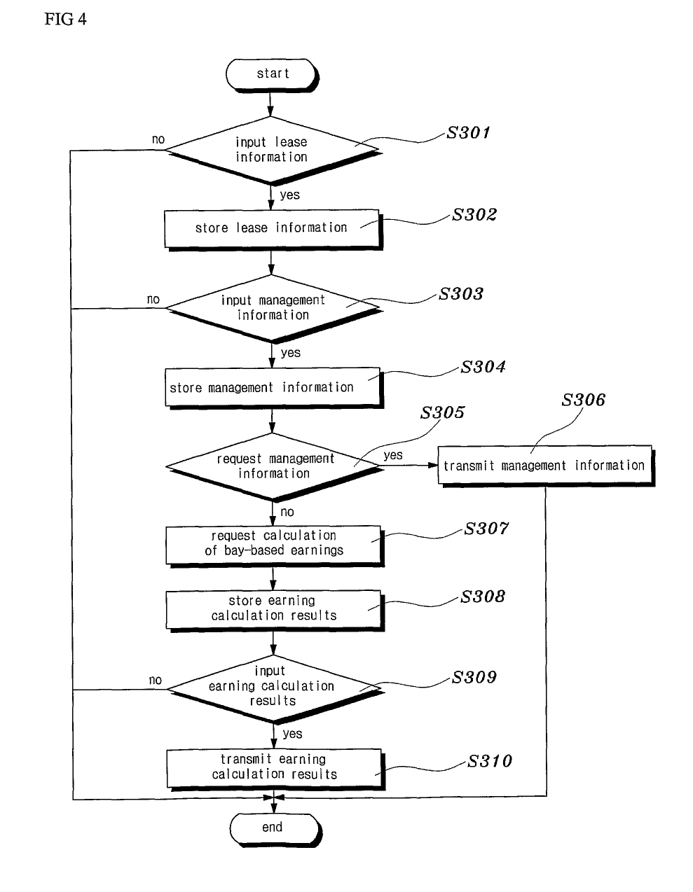

FIG. 4 is a flowchart illustrating the method of managing the golf range in accordance with the embodiment of the present invention.

The control unit 23 determines whether lease information has been input from the golf range assignment server 30 at step S301. In this case, the lease information indicates the status of lease of bays that have been leased to lessees. Furthermore, if the lease information has been input, the lease information is stored in the assignment information DB 25 at step S302. Thereafter, when the operation of the bays of the golf range is initiated, it is determined whether its related management information, that is, the status of use of a corresponding bay, has been input at step S303, the input management information is stored in the management information DB at step S304. At this time, it is determined whether a management information request signal for requesting management information has been input from any one of the first to n-th lessee terminals 10-1, . . . , 10-n at step S305. If, as a result of the determination, the management information request signal has been input, management information is transmitted to the corresponding lessee S306. If the management information request signal has not been input, an earning calculation request is made by outputting management information to the bay-based earning calculation unit 24 at step S307. The control unit 23 receives bay-based earning calculation results from the bay-based earning calculation unit 24, and stores the results in the assignee DB for respective lessees at step S308. Furthermore, it is determined whether a request signal requesting earning calculation results has been input from any one of the first to n-th lessee terminals at step S309, and the earning calculation results are transmitted to the corresponding lessee at step S310 if the signal requesting the earning calculation results has been input.

The operation of the golf range management system and the golf range management method according to the present invention is described below.

The assignment server of the management system of the present invention enables the bays of the golf range, other than bays that are directly managed by the constructor of the management system, to be leased to lessees. If there are no bays that are directly managed by the constructor, all the bays are leased, and the lessees, to which the bays are leased by the assignment server, complete private entrepreneur registration and manage the bays of the golf range. Furthermore, the assignment server may lease subsidiary facilities other than the bays. The lease methods may be divided into methods in which a security deposit and lease fees vary according to bay, and methods in which the same security deposit and lease fees are fixed for all the bays. The assignment server is connected to a management system via a communication network. However, it is possible to lease bays off-line and transmit lease information to the control unit.

Meanwhile, the control system of the management system receives bay-based lease information from the assignment information DB constructed by the assignment server, receives management information to calculate bay-based earnings, and calculates earnings, management fees and lease fees, which are generated from respective bays, using the previously constructed management information DB. The earning calculation method may vary as described above. The earnings may be calculated in consideration of the difference between the numbers of uses of bays, or may be calculated with a security deposit and lease fees varying according to bay. This is performed in the earning calculation unit. The control unit calculates earnings in the earning calculation unit based on the information stored in the member information DB, the management information DB and the assignee DB, displays bay-based earnings, which are obtained by subtracting management fees and various expenses from gross earnings, on respective lessee terminals, and receives the management fees and the various expenses after distributing and paying the earnings.

Furthermore, respective lessees can always check the current status of bays, the status of earnings and the status of expenses.

The management agency manages the management system according to the present invention is a professional management agency that manages the management system, fixes and receives management service fees and takes charge of the operation, management, marketing and safety of the golf range, which is a separate corporation, not a constructor or private entrepreneur.

Although, in the above-described embodiment, the case of leases has been described, the present invention may be applied to the case of registration sales. In this case, the lessees are replaced by registered owners, and bays are assigned in a registered manner and managed by a management agency. The difference in the method of receiving management fees and expenses is that separate usage fees are not paid.

### INDUSTRIAL APPLICABILITY

Accordingly, the present invention provides advantages in that respective bays of the golf range can be leased so that the lessees of the respective bays are private entrepreneurs. Accordingly, the private entrepreneurs can receive more tax saving benefits compared to direct management corporations or an individual entrepreneur. In the case of lease, the lessees of respective bays can invest small amounts of money in the leasing and management of golf ranges, which are the core of the leisure industry.

Furthermore, the present invention allows respective bays of the golf range, which require a large amount of money, to be leased, so that a business entity, such as a constrictor or landowner, can reduce the financial burden because he or she receives security deposits, and can reduce risk factors related to the golf range business because monthly earnings are guaranteed.

Furthermore, the management system and method according to the present invention are managed by the management agency and can efficiently calculate earnings for respective bays using the assignment information DB, the management information DB, the assignee DB and the member information DB as well as the assignment server, so that they are advantageous in that the private entrepreneurs of respective bays can always and easily check the status of earnings when management information is input, and in that customers can be effectively attracted by the large number of operators because a plurality of private entrepreneurs are entities that manage the golf range.

What is claimed is:

1. A system for managing a golf range, the system having a plurality of bays, comprising:
an assignment server for assigning the plurality of bays to assignees;
a management server for receiving assignment information from the assignment server, calculating earnings of respective assignees based on the management information for management of the golf range, and providing information about earnings calculated for the respective bays; and
a plurality of assignee terminals connected to the servers and configured to be assigned desired bays by the assignment server, and request and receive management information regarding their assigned bays.

2. The system as set forth in claim 1, wherein the assignment is leases and the assignees are lessees.

3. The system as set forth in claim 2, wherein the management server comprises:
an assignment information DataBase (DB) for storing assignment information for the respective assignees;
a management information DB for storing detailed information about management of the bays;
an assignee DB for storing information about the assignees;
a member DB for storing customer member information;
a management information input unit for receiving bay-based management information;
a control unit for controlling the elements such that earnings are calculated for respective bays based on input management information and assignment information; and
a bay-based earning calculation unit for calculating the earnings for respective bays.

4. The system as set forth in claim 2, wherein the bay-based earning calculation unit calculates the earnings such that the generated earnings are sequentially distributed to the assignees.

5. The system as set forth in claim 3, wherein the bay-based earning calculation unit calculates the earnings such that the earnings are distributed to the assignees based on data on use of the bays, with security deposits and lease fees being differently fixed for the bays.

6. The system as set forth in claim 3, wherein the bay-based earning calculation calculates the earnings such that the generated earnings are distributed to the assignees in proportion to the number of bays of each assignee.

7. The system as set forth in claim 1, wherein the assignment is registration sales and the assignees are registered owners.

8. A method of managing a golf range by assigning a plurality of bays, comprising the steps of:
determining whether information about assignment of the bays has been input, and storing the input assignment information;
determining whether information about management of the bays has been input, and storing the input management information;
calculating earnings for the respective bays based on the assignment information and the management information; and
transmitting information about the earnings, which are calculated for the respective bays, to the corresponding assignees who are assigned the bays.

9. The method as set forth in claim 8, wherein the assignment is leases and the assignees are lessee.

10. The method as set forth in claim 9, wherein the step of calculating earnings comprises the step of calculating the earnings such that the generated earnings are sequentially distributed to the assignee.

11. The method as set forth in claim 9, wherein the step of calculating earnings comprises the step of calculating the earnings such that the earnings are distributed to the assignees based on data on use of the bays, with security deposits and lease fees being differently fixed for the bays.

12. The method as set forth in claim 9, wherein the step of calculating earnings comprises the step of calculating the earnings such that the generated earnings are distributed to the assignees in proportion to the number of bays of each assignee.

13. The method as set forth in claim 8, wherein the assignment is registration sales and the assignees are registered owners.
